(19) United States
(12) Patent Application Publication
(10) Pub. No.: US 2004/0254919 A1
(43) Pub. Date: Dec. 16, 2004

(54) Log parser

(75) Inventor: Gabriele Giuseppini, Redmond, WA (US)

Correspondence Address: LEE & HAYES PLLC, 421 W RIVERSIDE AVENUE SUITE 500, SPOKANE, WA, 99201

(73) Assignee: MICROSOFT CORPORATION, REDMOND, WA (US)

(21) Appl. No.: 10/461,672

(22) Filed: Jun. 13, 2003

(51) Int. Cl. G06F 7/00

(52) U.S. Cl. 707/3

(57) ABSTRACT

Systems and methods for parsing an activity log are described. In one aspect, a query against logged data is received. The query is based on a log parser grammar that has been designed to parse activity logs of multiple different data formats. Responsive to receiving the query, the logged data is parsed to generate query results. Output data is created from the query results.

### TECHNICAL FIELD

The invention pertains to data processing.

### BACKGROUND

Activity logs are commonly used by system administrators to record events of interest. The type of information stored in any activity log is generally a function of the purpose of the monitoring application/tool used to generate and maintain the log. That is, different monitoring tools are generally used to generate activity logs for different types of system activity. For instance, one monitoring tool may log Web site traffic, another tool used to monitor Intranet activity, yet another tool used to record information associated with exception handing, computer system performance, resource accesses, file generation and modification events, and/or the like. Thus, the particular monitoring tool(s) that is/are to be used to log data is based on the type(s) of monitoring to be performed (i.e., the events to be monitored).

Respective ones of multiple different activity logging tools generally output data (logged data) in any of multiple possible document and data formats. Such data formats include, for example, third-party proprietary data format(s), comma-separated value (CSV), Extensible Markup Language (XML), ASCII text, World Wide Web Consortium (W3C), Internet Information Service (IIS), and/or other data formats. Since a administrator will typically need multiple activity logging tools to adequately monitor application, system, network, and or other events, the system administrator will also require multiple custom-built tools to parse, present/view, and/or export the resulting logged data, which is typically of different data formats. This is a substantially onerous requirement, especially in view of the many different types of events that generally need to be logged, and in view of the diverse data formats typically output by respective ones of the logging tools.

Accordingly, systems and methods that do not require use of multiple specifically designed and independent tools to parse, present/view, and/or export activity logs of multiple different respective data formats are greatly desired.

### SUMMARY

Systems and methods for parsing an activity log are described. In one aspect, a query against logged data is received. The query is based on a log parser grammar that has been designed to parse activity logs of multiple different data formats. Responsive to receiving the query, the logged data is parsed to generate query results. Output data is created from the query results.

### BRIEF DESCRIPTION OF THE DRAWINGS

In the figures, the left-most digit of a component reference number identifies the particular figure in which the component first appears.

FIG. 1 is a block diagram of an exemplary computing environment within which systems and methods for log parser may be implemented.

FIG. 2 is a block diagram that shows further exemplary aspects of system memory of FIG. 1, including application programs and program data for log parser.

FIG. 3 shows an exemplary procedure for log parser. In one implementation, the operations of FIG. 3 are implemented by the log parser 202 of FIG. 2. In another implementation, the operations of FIG. 3 are implemented by a third-party application that interfaces with one or more Common Object Model (COM) objects exposed by a log parser common library of FIG. 2.

### DETAILED DESCRIPTION

Overview

Systems and methods for a log parser are described below. The log parser is a versatile tool that runs Structured Query Language (SQL)-type queries against source files (i.e., log files) to implement many activity log related tasks). SQL-type queries (i.e., the LogParser's SQL queries) do not follow exactly the ANSI standard for the SQL language. In addition, Log Parser's SQL queries add some elements for tasks not available in the ANSI standard. Such tasks include, for example, importing, parsing, presenting, and exporting many different input log file data formats (e.g., CSV, XML, text, W3C, IIS, database table, WINDOWS event logging, and other data formats). Additionally, the log parser provides for filtering log entries, searching for data and patterns in files of various data formats, converting log files from one data format to another data format, creation of formatted reports and XML files containing data retrieved from different log sources, exporting data (all or selected portions of log files) to database tables (e.g., SQL tables), data mining, and so on.

To these ends, the log parser extracts records, using one or more SQL-type queries, from source files of various input source types. The log parser query engine processes these records—filtering, grouping, and ordering them according to the conditions specified in the SQL-type query. Log parser then presents the processed records (i.e., the query results) to an end-user, and/or writes the query results to one or more target output files or database tables in one or more selected data formats supported by the log parser.

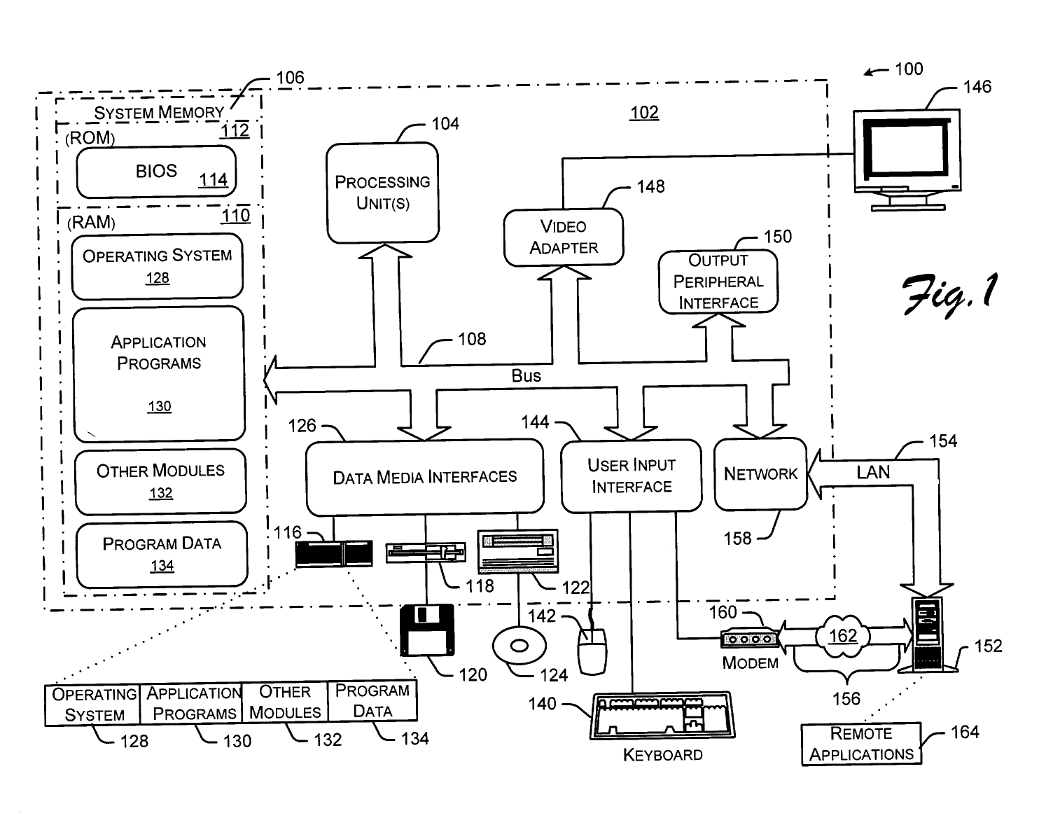

In this manner the log parser makes it possible to request information from log files of almost any data format and produce the desired information (i.e., the query results) for presentation and/or storage in a file of almost any data format or into an SQL database. Thus, log parser addresses the limitations of conventional activity log interfacing techniques that require multiple specifically designed and independent tools to parse, present/view, and/or export activity logs of multiple different respective data formats. These and other aspects of the log parser, including the exemplary operating environment of FIG. 1 and exemplary log parser grammar for generating the SQL-type queries are now described in greater detail.

Exemplary Operating Environment

Turning to the drawings, wherein like reference numerals refer to like elements, the invention is illustrated as being implemented in a suitable computing environment. Although not required, the invention is described in the general context of computer-executable instructions, such as program modules, being executed by a personal computer. Program modules generally include routines, programs, objects, components, data structures, etc., that perform particular tasks or implement particular abstract data types.

FIG. 1 illustrates an example of a suitable computing environment 100 on which the subsequently described systems, apparatuses and methods for log parser may be implemented (either fully or partially). Exemplary computing environment 100 is only one example of a suitable computing environment and is not intended to suggest any limitation as to the scope of use or functionality of systems and methods the described herein. Neither should computing environment 100 be interpreted as having any dependency or requirement relating to any one or combination of components illustrated in computing environment 100.

The methods and systems described herein are operational with numerous other general purpose or special purpose computing system environments or configurations. Examples of well known computing systems, environments, and/or configurations that may be suitable for use include, but are not limited to, personal computers, server computers, multiprocessor systems, microprocessor-based systems, network PCs, minicomputers, mainframe computers, distributed computing environments that include any of the above systems or devices, and so on. Compact or subset versions of the framework may also be implemented in clients of limited resources, such as handheld computers, or other computing devices. The invention may also be practiced in distributed computing environments where tasks are performed by remote processing devices that are linked through a communications network. In a distributed computing environment, program modules may be located in both local and remote memory storage devices.

As shown in FIG. 1, computing environment 100 includes a general-purpose computing device in the form of a computer 102. The components of computer 102 can include, by are not limited to, one or more processors or processing units 104, a system memory 106, and a bus 108 that couples various system components including system memory 106 to processor 104. The system bus 108 represents one or more of any of several types of bus structures, including a memory bus or memory controller, a peripheral bus, an accelerated graphics port, and a processor or local bus using any of a variety of bus architectures. By way of example, and not limitation, such \-architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus also known as Mezzanine bus.

Computer 102 typically includes a variety of computer readable media. Such media may be any available media that is accessible by computer 102, and it includes both volatile and non-volatile media, removable and non-removable media. In FIG. 1, system memory 106 includes computer readable media in the form of volatile memory, such as random access memory (RAM) 110, and/or non-volatile memory, such as read only memory (ROM) 112. A basic input/output system (BIOS) 114, containing the basic routines that help to transfer information between elements within computer 102, such as during start-up, is stored in ROM 112. RAM 110 typically contains data and/or program modules that are immediately accessible to and/or presently being operated on by processor 104.

Computer 102 may further include other removable/non-removable, volatile/non-volatile computer storage media. For example, FIG. 1 illustrates a hard disk drive 116 for reading from and writing to a non-removable, non-volatile magnetic media (not shown and typically called a “hard drive”), a magnetic disk drive 118 for reading from and writing to a removable, non-volatile magnetic disk 120 (e.g., a “floppy disk”), and an optical disk drive 122 for reading from or writing to a removable, non-volatile optical disk 124 such as a CD-ROM/R/RW, DVD-ROM/R/RW/+R/RAM or other optical media. Hard disk drive 116, magnetic disk drive 118 and optical disk drive 122 are each connected to bus 108 by one or more interfaces 126.

The drives and associated computer-readable media provide nonvolatile storage of computer readable instructions, data structures, program modules, and other data for computer 102. Although the exemplary environment described herein employs a hard disk, a removable magnetic disk 120 and a removable optical disk 124, it should be appreciated by those skilled in the art that other types of computer readable media which can store data that is accessible by a computer, such as magnetic cassettes, flash memory cards, digital video disks, random access memories (RAMs), read only memories (ROM), and the like, may also be used in the exemplary operating environment.

A user may provide commands and information into computer 102 through input devices such as keyboard 140 and pointing device 142 (such as a “mouse”). Other input devices (not shown) may include a microphone, joystick, game pad, satellite dish, serial port, scanner, camera, etc. These and other input devices are connected to the processing unit 104 through a user input interface 144 that is coupled to bus 108, but may be connected by other interface and bus structures, such as a parallel port, game port, or a universal serial bus (USB).

A monitor 146 or other type of display device is also connected to bus 108 via an interface, such as a video adapter 148. In addition to monitor 146, personal computers typically include other peripheral output devices (not shown), such as speakers and printers, which may be connected through output peripheral interface 150.

Computer 102 may operate in a networked environment using logical connections to one or more remote computers, such as a remote computer 152. Remote computer 152 may include many or all of the elements and features described herein relative to computer 102. Logical connections shown in FIG. 1 are a local area network (LAN) 154 and a general wide area network (WAN) 156. Such networking environments are commonplace in offices, enterprise-wide computer networks, intranets, and the Internet.

When used in a LAN networking environment, computer 102 is connected to LAN 154 via network interface or adapter 158. When used in a WAN networking environment, the computer typically includes a modem 160 or other means for establishing communications over WAN 156. Modem 160, which may be internal or external, may be connected to system bus 108 via the user input interface 144 or other appropriate mechanism. Depicted in FIG. 1, is a specific implementation of a WAN via the Internet. Here, computer 102 employs modem 160 to establish communications with at least one remote computer 152 via the Internet 162.

In a networked environment, program modules depicted relative to computer 102, or portions thereof, may be stored in a remote memory storage device. Thus, e.g., as depicted in FIG. 1, remote application programs 164 may reside on a memory device of remote computer 152. It will be appreciated that the network connections shown and described are exemplary and other means of establishing a communications link between the computers may be used.

A number of program modules may be stored on the hard disk, magnetic disk 120, optical disk 124, ROM 112, or RAM 110, including, e.g., an operating system (OS) 128 to provide a run-time environment, application programs 130 for log parser, other program modules 132 (e.g., device drivers, etc.), and program data 134 such source code, log file queries based on log parser grammar, intermediate data, and/or the like.

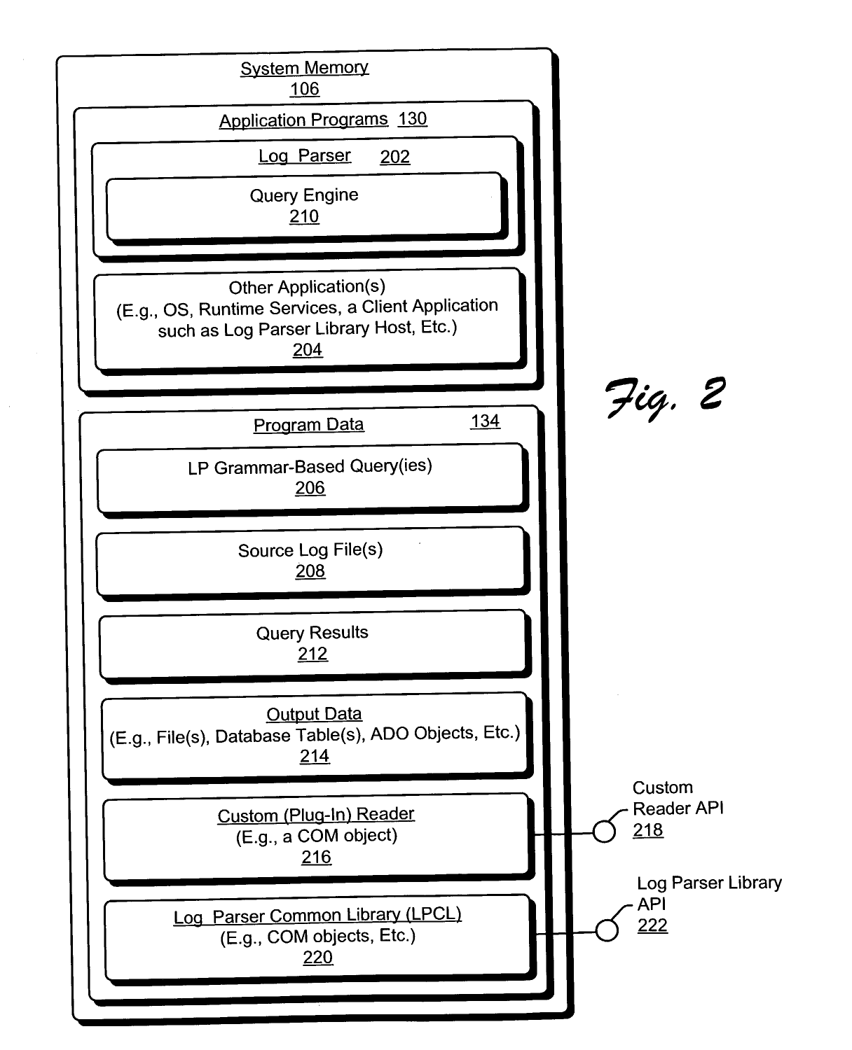

FIG. 2 is a block diagram that shows further exemplary aspects of system memory 106 of FIG. 1, including application programs 130 and program data 134 for log parser. In this implementation, application programs 130 include, for example log parser 202 and other applications 204 such as the operating system (OS) 128 of FIG. 1, and a runtime to provide the log parser 202 with services such as Just-In-Time (JIT) compiling, memory management, and so on. The log parser 202 allows a user or executed script to assert/run/execute a log parser grammar-based query 206, which is hereinafter often simply referred to as a “query”, against one or more source log files 208. Exemplary log parser grammar is described in greater detail below in reference to TABLES 1-17.

Responsive of receiving a query 206 against a log file 208, the query engine 210 portion of the log parser 202 parses the log parser grammar-based query 206 to generate query result(s) 212, which represent the desired/queried-for information. Query 206 may specify any of numerous different functions for the query engine 212 to perform with respect to the specified source log file(s) 208. Exemplary such functions are described in greater detail below in reference to TABLE 2. As indicated above, source log files(s) 208, or “log(s)” can be in any of numerous different document and data formats, for instance, CSV, XML, text, W3C, IIS, database table, WINDOWS event logging, and/or other data formats.

For example, the query engine 210 supports a dialect of Structured Query Language (SQL) syntax, as described above with respect to the term SQL-type. The query engine 210 treats an input source 208 as a relational table, so fields act as table columns and each field is assigned a data type. Data types can be STRING, INTEGER, REAL, and TIMESTAMP. Any value can assume the NULL value. A query 206 can embed fields in functions, such as STRCAT, STRLEN, and REVERSEDNS, and can nest functions multiple times. For example:

SUBSTR(cs-uri-stem, INDEX_OF(cs-uri-stem, TO_STRING(sc-status))).

In addition, the query engine 210 supports the aggregate functions SUM, COUNT, AVG, MIN, and MAX. It supports the most common operators, such as greater than (>), IS NULL, LIKE, and IS IN. And the Log Parser SQL engine supports most standard SQL query clauses: SELECT, WHERE, GROUP BY, HAVING, and ORDER BY.

In one implementation, the log parser 202 allows third-party software developers to add-value to the log parser 202 via one or more plug-ins. For example, to read and parse an input source log file 208 of a particular data format, the log parser will interface with a plug-in such as the custom reader 216. In this implementation, the custom reader 216 is a Common Object Model (COM) object that exposes its operational capabilities via an Application Program Interface (API) 218 that is designed to interface with the log parser 202.

To generate query result(s) 212, the query engine 210 may perform any combination of log entry (i.e., record) extraction and/or filtering operations, searching for data and/or patterns in files of various data formats, grouping and/or ordering extracted information according to the conditions specified in the query 206. The log parser 202 generates output data 214 from the query results 212. The output data 214 may represent the end results of converting log files from one data format to another data format, creation of formatted reports and XML files containing data retrieved from different log sources, exporting data (all or selected portions of log files) to database tables (e.g., SQL tables), data mining, and so on. For example, “converting log files” is the effect of running a query 206 on format “A”, generating query result(s) 212 and writing the result(s) to format “B”. The “creation of formatted reports” and “exporting data to database tables” is accomplished in analogous operations.

The log parser 202 presents query result(s) 212 to an end-user (e.g., via the display monitor 146 of FIG. 1), writes the query result(s) one or more database tables, and/or writes the query result(s) into data file(s) of specified data format, and so on. For purposes of discussion, query results(s) 212 that have been exported to database tables, files, and so on, are represented as “output data” 214.

Exemplary Log Parser Grammar

Table 1 lists exemplary grammar used by the query engine 210.

TABLE 1
EXEMPLARY LOG PARSER QUERY ENGINE GRAMMAR

| Element | Syntax |
|---|---|
| <query> | <select_clause> <from_clause> |
| | [<to_clause>] |
| | [<where_clause>] [<group_by_clause>] |
| | [<having_clause>] [<order_by_clause>] |
| <select_clause> | SELECT [TOP<integer>] [DISTINCT\| |
| | ALL] <selection_list> \| |
| | SELECT [TOP<integer>] [DISTINCT\| |
| | ALL] * |
| <selection_list> | <selection_list_el> \| |
| | <selection_list_el>, <selection_list> |
| <selection_list_el> | <field_expr> AS <alias> \| |
| | <field_expr> |
| <from_clause> | FROM <from_entity> |
| <to_clause> | TO <to_entity> \| |
| | <null> |
| <where_clause> | WHERE <expression> \| |
| | <null> |
| <expression> | <term1> OR <expression> \| |
| | <term1> |
| <term1> | <term2> AND <term1> \| |
| | <term2> |
| <term2> | <field_expr> <rel_op> <value> \| |
| | <field_expr> LIKE <like_value> \| |
| | <field_expr> <unary_op> \| |
| | <field_expr> <incl_op> <content> \| |
| | <field_expr> <rel_op> ALL\|ANY |
| | <content> \| |
| | (<field_expr_list>) <incl_op> <content> \| |
| | (<field_expr_list>) <rel_op> |
| | ALL\|ANY <content> \| |
| | NOT <term2> \| |
| | (<expression>) |
| <content> | (<value_list>) \| |
| | (<query>) |
| <group_by_clause> | GROUP BY <field_expr_list> \| |
| | <null> |
| <having_clause> | HAVING <expression> \| |
| | <null> |
| <order_by_clause> | ORDER BY <field_expr_list> [ASC\| |
| | DESC] \| |
| | ORDER BY * [ASC\|DESC] \| |
| | <null> |
| <field_expr_list> | <field_expr> \| |
| | <field_expr>, <field_expr_list> |
| <field_expr> | <sqlfunction_expr> \| |
| | <function_expr> \| |
| | <value> \| |
| | <field> \| |
| | <alias> |
| <sqlfunction_expr> | <sqlfunction> (<field_expr>) \| |
| | COUNT (*) \| |
| | COUNT (<field_list>) |
| <function_expr> | <function> (<field_expr_list>) |
| <field_list> | <field> \| |
| | <field>, <field_list> |
| <value_list> | <value_list_row> \| |
| | <value_list_row>; <value_list> |
| <value_list_row> | <value> \| |
| | <value>, <value_list_row> |
| <sqlfunction> | SUM\|AVG\|MAX\|MIN |
| <function> | STRCAT\|SUBSTR\|STRREV\|TO_INT \| |
| | TO_REAL\|TO_STRING\|TO_DATE \| |
| | TO_TIME \| |
| | TO_TIMESTAMP\|TO_HEX\| |
| | REPLACE_STR \| REPLACE_CHR \| |
| | STRLEN\|INDEX_OF\|LAST_INDEX_OF \| |
| | ADD\|SUB \| |
| | DIV\|MUL\|REPLACE_IF_NULL \| |
| | REPLACE_IF_NOT_NULL \| |
| | UNIQUE_ID\|SYSTEM_TIMESTAMP \| |
| | SYSTEM_DATE \| |
| | SYSTEM_TIME\|SYSTEM_UTCOFFSET \| |
| | TO_LOCALTIME \| |
| | TO_UTCTIME\|TO_LOWERCASE \| |
| | TO_UPPERCASE \| |
| | QUANTIZE\|REVERSEDNS\|URLESCAPE \| |
| | URLUNESCAPE \| |
| | SQR\|SQRROOT\|LOG\|EXP \| |
| | EXTRACT_VALUE \| |
| | WIN32_ERROR_DESCRIPTION \| |
| | EXTRACT_TOKEN\|RESOLVE_SID |
| <value> | <string_value> \| |
| | <real> \| |
| | <integer> \| |
| | <timestamp> \| |
| | NULL |
| <rel_op> | <\|>\|<>\|=\|<=\|>= |
| <incl_op> | IN\|NOT IN |
| <unary_op> | IS NULL\|IS NOT NULL |
| <timestamp> | TMESTAMP (<string_value>, |
| | <timestamp_format>) |
| <timestamp_format> | ‘<timestamp_separator> |
| | 0*7(<timestamp_element> |
| | <timestamp_separator>)’ |
| <timestamp_element> | 1*4 y \| |
| | 1*4 M \| |
| | 1*4 d \| |
| | l*2(H\|h)\| |
| | 1*2 m \| |
| | 1*2 s |
| <timestamp_separator> | <any_char_except_timestamp_element> \| |
| | <null> |
| <like_value> | ‘*(<any_char>\|%\|_) ’ |
| <string_value> | ‘*(<any_char>)’ |

Table 2 lists exemplary functions that can be directed to the log parser 202.

TABLE 2
Log Parser Functions
SUBSTR(string <STRING>, start <INTEGER> [, length <INTEGER>])
STRCAT(string1 <STRING>, string2 <STRING>)
STRLEN(string <STRING>)
STRREV(string <STRING>)
TO_INT(argument <any type>)
This function converts the specified argument to an integer. If the
argument cannot be converted, the function returns NULL.
TO_REAL(argument <any type>)
TO_STRING(argument <INTEGER|REAL>)|
(timestamp <TIMESTAMP>, format <STRING>)
TO_DATE(timestamp <TIMESTAMP>)
This function transforms the specified argument into a timestamp
containing date values only.
TO_TIME(timestamp <TIMESTAMP>)
This function transforms the specified argument into a timestamp
containing time values only.
TO_TIMESTAMP(dateTime1 <TIMESTAMP>, dateTime2
<TIMESTAMP>)|
(string <STRING>, format <STRING>)
The first example combines two timestamps containing date and time
values into a single timestamp. The second example parses a string into a
timestamp, according to the timestamp pictures defined in the second
argument.
TO_HEX(argument <INTEGER>)
This function returns the hexadecimal string representation of the integer
argument.
REPLACE_STR( string <STRING>, searchString <STRING>,
replaceString <STRING>)
REPLACE CHR( string <STRING>, searchCharacters <STRING>,
replaceString <STRING>)
INDEX_OF(string <STRING>, searchStr <STRING>)
LAST_INDEX_OF(string <STRING>, searchStr <STRING>)
ADD(argument1 <any type>, argument2 <any type>)
SUB(argument1 <any type>, argument2 <any type>)
DIV(argument1 <INTEGER|REAL>, argument2 <INTEGER|REAL>)
MUL(argument1 <INTEGER|REAL>, argument2 <INTEGER|REAL>)
REVERSEDNS(ipAddress <STRING>)
If the argument does not specify a valid IP address (IPv4 or IPv6), or if the
IP address cannot be resolved, the result is the argument string itself.
REPLACE_IF_NULL(argument <any type>, replaceValue <any type>)
This function replaces the specified argument whenever it has a NULL
value.
REPLACE_IF_NOT_NULL(argument <any type>, replaceValue <any
type>)
This function replaces the specified argument whenever it has a value
other than NULL.
SYSTEM_TIMESTAMP( )
SYSTEM_DATE( )
SYSTEM_TIME( )
SYSTEM_UTCOFFSET( )
This function returns the absolute value of the current time zone offset.
TO_LOCALTIME(timestamp <TIMESTAMP>)
TO_UTCTIME(timestamp <TIMESTAMP>)
TO_LOWERCASE(string <STRING>)
TO_UPPERCASE(string <STRING>)
UNIQUEID ([startValue <INTEGER>])
This function returns a unique INTEGER value every time a row is
generated. The default start value is ‘1’.
URLESCAPE(url <STRING> [, codepage <INTEGER>])
This function returns the HEX encoding (as specified in RFC2396) of the
argument passed. The codepage used by default is UTF-8.
URLUNESCAPE(url <STRING> [, codepage <INTEGER>])
This function returns the HEX un-encoding (as specified in RFC2396) of
the argument passed. The codepage used by default is UTF-8.
SQR(argument <INTEGER | REAL>)
SQRROOT(argument <INTEGER | REAL>)
LOG(argument <INTEGER | REAL>)
EXP(argument <INTEGER | REAL>)
QUANTIZE(argument <INTEGER | REAL | TIMESTAMP>,
QUANTIZATION<INTEGER | REAL>)
This function rounds the specified value to the lowest sub-multiple of the
quantization value. When used with timestamps, the quantization argument
refers to the number of seconds.
EXTRACT_VALUE(argument <STRING>, key <STRING> [, separator
<STRING>])
This function parses a list of “valuename = value” strings separated by the
character passed as the separator argument and returns the value portion
identified by the key argument. The separator value has a default value of
“&”. For example:
“EXTRACT_VALUE( ‘siteID=example.com&countrycode=usa’,
‘countrycode’)”returns ‘usa’.
WIN32_ERROR_DESCRIPTION(win32ErrorCode <INTEGER> )
This function returns a string containing the WINDOWS error message
represented by the specified error code.
EXTRACT_TOKEN(argument <STRING>, index <INTEGER>[,
separator <STRING>]) This function parses a list of strings separated by
the separator argument string and returns the portion identified by the 0-
based index argument. The separator value has a default value of ‘,’. For
example:EXTRACT_TOKEN(‘value1,value2,value3,value4’, ‘2’)
returns ‘value3’.
RESOLVE_SID( sid <STRING> [, computerName <STRING>])
This function returns the fully specified account name represented by the
argument SID. If the argument doesn't specify a valid SID, or if the SID
cannot be resolved, the function returns the SID string itself. The optional
computerName argument specifies the computer on which to perform the
account lookup.

Table 3 lists exemplary log parser 202 timestamp elements.

TABLE 3
EXEMPLARY TIMESTAMP ELEMENTS

| Timestamp | |
|---|---|
| Element | Description |
| y | 1-digit year |
| yy | 2-digit year |
| yyy | 3-digit year |
| yyyy | 4-digit year |
| M | month as digit without leading zeros |
| MM | month as digit with leading zeros |
| MMM | month as 3-character abbreviation of month name |
| MMMM | month as full month name |
| d | day as digit without leading zeros |
| dd | day as digit with leading zeros |
| ddd | day as 3-character abbreviation of day name |
| dddd | day as full day name |
| h,H | hour without leading zeros |
| hh,HH | hour with leading zeros |
| m | minutes without leading zeros |
| mm | minutes with leading zeros |
| s | seconds without leading zeros |
| ss | seconds with leading zeros |
| l | milliseconds without leading zeros |
| ll | milliseconds with leading zeros |
| n | nanoseconds without leading zeros |
| nn | nanoseconds with leading zeros |

Table 4 lists the wildcard characters used by the <like_value> operand of the LIKE operator.

TABLE 4
EXEMPLARY WILDCARD CHARACTERS

| Character | Use For |
|---|---|
| % | Any string |
| _{—} | Any character |
| \% | The % character |
| \\ | The \ character |
| \<any_character> | The specified character |

To specify Unicode characters in <string_value> literals, type them in the following notation: “\unnnn”, where nnnn refers to the four-digit hexadecimal representation of the Unicode character. For example, to specify a TAB character, type the following: “\u0009”.\

Table 5 lists the escape characters accepted by log parser 202 when parsing <string_value> literals.

TABLE 4
EXEMPLARY ESCAPE CHARACTERS

| Escape sequence | Converted to |
|---|---|
| \’ | The ‘ character |
| \\grave{ } | The \grave{ } character |

To specify hexadecimal values, use the “0x” prefix. For example: 0x000f2.

Exemplary Source Log File Input Data Formats

This implementation of the log parser 202 supports the following source log file 208 input data formats:

IISW3C: This is the IIS W3C Extended log file format.

IIS: This is the IIS log file format.

IISMSID: This is the log format for files generated by IIS when the MSIDFILT filter or the CLOGFILT filter is installed.

NCSA: This is the IIS NCSA Common log file format.

ODBC: This is the IIS ODBC format, which sends log files to an ODBC-compliant database.

BIN: This is the IIS binary log file format.

URLSCAN: This is the format for URLScan logs.

HTTPERR: This is the IIS 6.0 HTTP error log file format.

EVT: This is the Microsoft WINDOWS Event Messages format.

TEXTWORD: This is a generic text file, where the TEXT value is any separate word.

TEXTLINE: This is a generic text file, where the TEXT value is any separate line.

CSV: This is a comma-separated list of values.

W3C: This is a generic W3C log file, such as a log generated by WINDOWS Media Services or Personal Firewall.

FS: This provides information about file and directory properties.

### IIS Log File Formats

The log parser 202 can query any IIS log file data formats.

1. IISW3C

This input data format parses IIS W3C Extended log files 208. Table 6 lists IISW3C fields and corresponding data types.

TABLE 6

| Field | Data Type |
|---|---|
| LogFilename | STRING |
| LogRow | INTEGER |
| date | TIMESTAMP |
| time | TIMESTAMP |
| c-ip | STRING |
| cs-username | STRING |
| s-sitename | STRING |
| s-computername | STRING |
| s-ip | STRING |
| s-port | INTEGER |
| cs-method | STRING |
| cs-uri-stem | STRING |
| cs-uri-query | STRING |
| sc-status | INTEGER |
| sc-substatus | INTEGER |
| sc-win32-status | INTEGER |
| sc-bytes | INTEGER |
| cs-bytes | INTEGER |
| time-taken | INTEGER |
| cs-version | STRING |
| cs-host | STRING |
| cs(User-Agent) | STRING |
| cs(Cookie) | STRING |
| cs(Referer) | STRING |
| s-event | STRING |
| s-process-type | STRING |
| s-user-time | REAL |
| s-kernel-time | REAL |
| s-page-faults | INTEGER |
| s-total-procs | INTEGER |
| s-active-procs | INTEGER |
| s-stopped-procs | INTEGER |

Fields that are not logged in the log file are returned as NULL.

The IISW3C input data format accepts the following values in the FROM statement:

A file name, or a comma-separated list of file names, including names that contain wildcards, such as LogFiles\W3SVC3\ex*.log.

An Active Directory® Services Interface (ADSI) path, or a comma-separated list of paths, specifying the virtual site or site name that hosts one or more logs files and whose log file(s) are to be parsed, enclosed in angle brackets (< >), such as <//MYCOMPUTER/W3SVC/1, //MYCOMPUTER/W3SVC/2>, <//FARM\W3SVC/www.s5.com> or <4, 9> when referring to the local computer.

The stdin command, used to pipe command executions, such as type extend1.log|LogParser “SELECT * from stdin”−i:IISW3C.

The following options are available for the IISW3C input data format:

iCodepage: Specifies the codepage in which the files are encoded; legal values are 1252, 0 (current system codepage), −1 (Unicode), 65001 (UTF-8), and so on. The default value is −2, meaning that log parser 202 determines the codepage based on the file name and the IIS metabase settings.

dQuotes: Specifies that the strings in the file should be enclosed in quotation marks (“ ”). Legal values are ON or OFF. The default value is OFF.

dirTime: Instructs the tool to return the #Date: directive as date/time when the date/time fields in the log file are NULL. Legal values are ON or OFF. The default value is OFF.

2. IIS

This input data format parses the Microsoft IIS log format files generated by IIS. Table 6 lists the IIS input data format fields and corresponding data types.

TABLE 7

| Field | Data Type |
|---|---|
| LogFileName | STRING |
| LogRow | INTEGER |
| UserIP | STRING |
| UserName | STRING |
| Date | TIMESTAMP |
| Time | TIMESTAMP |
| ServiceInstance | STRING |
| HostName | STRING |
| ServerIP | STRING |
| TimeTaken | INTEGER |
| BytesSent | INTEGER |
| BytesReceived | INTEGER |
| StatusCode | INTEGER |
| Win32StatusCode | INTEGER |
| RequestType | STRING |
| Target | STRING |
| Parameters | STRING |

The IIS input data format accepts the following values in the FROM clause:

A file name, or a comma-separated list of file names, including names containing wildcards, such as LogFiles\W3SVC3\in02*.log.

An ADSI path, or a comma-separated list of paths, specifying the virtual site or site name whose log files are to be parsed, enclosed between angle brackets ( [symbol] ), such as <//MYCOMPUTER/W3SVC/1, //MYCOMPUTER/W3SVC/2>, <//FARM/W3SVC/www.s5.com> or <4, 9> when referring to the local computer.

The stdin command, used to pipe command executions, such as type inetsv1.log|LogParser “SELECT * from stdin”-i:IIS.

The following options are available for the IIS input data format:

iCodepage: Specifies the codepage in which the files are encoded; legal values are 1252, 0 (current system codepage), −1 (Unicode), 65001 (UTF-8), and so on. The default value is −2, meaning that log parser 202 determines the codepage based on the filename and the IIS metabase settings.

locale: Specifies the locale to use when parsing the file's date and time values. Legal values are locale IDs (such as 1033) or locale names (such as JPN). The default value is the current system locale.

3. IISMSID

This input data format parses the Microsoft IIS log format files generated by IIS when the MSIDFILT filter or the CLOGFILT filter is installed. Table 8 lists the IISMSID input data format fields and corresponding data types.

TABLE 8

| Field | Data Type |
|---|---|
| LogFileName | STRING |
| LogRow | INTEGER |
| UserIP | STRING |
| UserName | STRING |
| Date | TIMESTAMP |
| Time | TIMESTAMP |
| ServiceInstance | STRING |
| HostName | STRING |
| ServerIP | STRING |
| TimeTaken | INTEGER |
| BytesSent | INTEGER |
| BytesReceived | INTEGER |
| StatusCode | INTEGER |
| Win32StatusCode | INTEGER |
| RequestType | STRING |
| Target | STRING |
| UserAgent | STRING |
| Referrer | STRING |
| GUID | STRING |
| PassportID | STRING |
| PartnerID | STRING |
| Parameters | STRING |

The IISMSID input data format accepts the following values in the FROM clause:

A file name, or a comma-separated list of file names, including names that contain wildcards, such as LogFiles\W3SVC3\inetsv*.log.

An ADSI path, or a comma-separated list of paths, specifying the virtual site or site name whose log files are to be parsed, enclosed in angle brackets (< >), such as<//GABRIEGI0/W3SVC/1, //GABRIEGI1/W3SVC/7>, <//FARM/W3SVC/www.s5.com>, or <4,9> when referring to the local computer.

The stdin command, used to pipe command executions, such as type inetsv2.log|LogParser “SELECT * from stdin”-i:IISMSID.

The following options are available for the IISMSID input data format:

clogfilt: Instructs log parser 202 to use the CLOGFILT value separator convention when parsing the supplied log files; legal values are ON or OFF. The default value is OFF.

iCodepage: Specifies the codepage in which the files are encoded; legal values are 1252, 0 (current system codepage), −1 (Unicode), 65001 (UTF-8), and so on. The default value is −2, meaning that log parser 202 determines the codepage based on the filename and the IIS metabase settings.

locale: Specifies the locale to use when parsing the file's date and time values; legal values are locale IDs (such as 1033) or locale names (such as JPN). The default value is the current system locale.

4. NCSA

This input data format parses NCSA Common log files. Table 9 lists the NCSA field names and corresponding data types.

TABLE 9

| Field | Data Type |
|---|---|
| LogFileName | STRING |
| LogRow | INTEGER |
| RemoteHostName | STRING |
| RemoteLogName | STRING |
| UserName | STRING |
| DateTime | TIMESTAMP |
| Request | STRING |
| StatusCode | INTEGER |
| BytesSent | INTEGER |

The NCSA input data format accepts the following values in the FROM clause:

A file name, or a comma-separated list of file names, including names that contain wildcards, such as LogFiles\W3SVC3\ncsa2*.log.

An ADSI path, or a comma-separated list of paths, specifying the virtual site or site name whose log files are to be parsed, enclosed in angle brackets ( [symbol] ) such as <//GABRIEGI0/W3SVC/1, //GABRIEGI1//W3SVC/7>, <//FARM/W3SVC/www.s5.com> or <4, 9> when referring to the local computer.

The stdin command, used to pipe command executions, such as type ncsa1.log|LogParser “SELECT * from stdin”-i:NCSA.

The option available for the NCSA input data format is as follows: iCodepage: Specifies the codepage in which the files are encoded; legal values are 1252, 0 (current system codepage), −1 (Unicode), 65001 (UTF-8), and so on. The default value is −2, meaning that log parser 202 determines the codepage based on the filename and the IIS metabase settings.

5. ODBC

This input data format reads the fields directly from the SQL table populated by IIS when the Web Server is configured to log to an ODBC target. Table 10 lists the ODBC input data format field names and corresponding data types.

TABLE 10

| Field | Data Type |
|---|---|
| ClientHost | STRING |
| UserName | STRING |
| LogTime | TIMESTAMP |
| Service | STRING |
| Machine | STRING |
| ServerIP | STRING |
| ProcessingTime | INTEGER |
| BytesRecvd | INTEGER |
| BytesSent | INTEGER |
| ServiceStatus | INTEGER |
| Win32Status | INTEGER |
| Operation | STRING |
| Target | STRING |
| Parameters | STRING |

The ODBC input data format accepts the following values in the FROM clause:

A complete specification of the table from which the fields are to be extracted, in the following form:

table:<tablename>;DSN:<dsn>;username:<username>;password:<pas sword>

An ADSI path, or a comma-separated list of paths, specifying the virtual site or site name whose log files are to be parsed, enclosed in angle brackets ( [symbol] ), such as<//GABRIEGI0/W3SVC/1, //GABRIEGI1/W3SVC/7>, <//FARM/W3SVC/www.s5.com> or <4, 9>when referring to the local machine.

There are no options available for the ODBC input data format.

6.0 BIN

This input data format reads the central binary log files generated by IIS 6.0. These log files contain all the requests received by all the virtual sites on the same server running IIS 6.0. Table 11 lists the BIN field names and corresponding data types.

TABLE 11

| Field | Data Type |
|---|---|
| LogFileName | STRING |
| RecordNumber | INTEGER |
| ComputerName | STRING |
| SiteID | INTEGER |
| DateTime | TIMESTAMP |
| ClientIpAddress | STRING |
| ServerIpAddress | STRING |
| ServerPort | INTEGER |
| Method | STRING |
| ProtocolVersion | STRING |
| ProtocolStatus | INTEGER |
| SubStatus | INTEGER |
| TimeTaken | INTEGER |
| BytesSent | INTEGER |
| BytesReceived | INTEGER |
| Win32Status | INTEGER |
| UriStem | STRING |
| UriQuery | STRING |
| UserName | STRING |

The BIN input data format accepts the following values in the FROM clause:

A file name, or a comma-separated list of file names, including names that contain wildcards, such as LogFiles\W3SVC\ra*.ibl.

An ADSI path, or a comma-separated list of paths, specifying the virtual site or site name whose log files are to be parsed, enclosed in angle brackets ( [symbol] ) such as<//GABRIEGI0/W3SVC/1>, <//FARM/W3SVC/www.s5.com> or <4>,<9> when referring to the local computer. If such a source is specified, the input source returns only those log entries relative to the site specified.

There are no options available for the BIN input data format.

7.0 URLSCAN

This input data format reads the URLScan log files generated by the URLScan filter if it is installed on IIS. Table 12 lists the URLScan field names and corresponding data types.

TABLE 11

| Field | Data Type |
|---|---|
| LogFileName | STRING |
| LogRow | INTEGER |
| Date | TIMESTAMP |
| ClientIP | STRING |
| Comment | STRING |
| SiteInstance | INTEGER |
| Url | STRING |

The URLScan input data format accepts the following values in the FROM clause:

A file name or a comma-separated list of file names, including names that contain wildcards, such as URLScan\*.log.

The URLSCAN command, to instruct log parser 202 to retrieve and parse all the currently available URLScan log files.

The stdin command, used to pipe command executions, such as type URLScan.log|LogParser “SELECT * from stdin”-i:URLSCAN.

There are no options available for the URLScan input data format.

8.0 HTTPERR

This input data format reads the IIS 6.0 HTTP error log files. Table 13 lists the HTTPERR field names and corresponding data types.

TABLE 13

| Field | Data Type |
|---|---|
| LogFileName | STRING |
| LogRow | INTEGER |
| date | TIMESTAMP |
| time | TIMESTAMP |
| src-ip | STRING |
| src-port | INTEGER |
| dst-ip | STRING |
| dst-port | INTEGER |
| cs-version | STRING |
| cs-method | STRING |
| cs-url | STRING |
| sc-status | INTEGER |
| s-site | STRING |
| s-reason | STRING |

The HTTPERR input data format accepts the following values in the FROM clause:

A file name or a comma-separated list of file names, including names that contain wildcards, such as HttpErr5*.log, HttpErr7*.log.

The HTTPERR command, to instruct log parser 202 to retrieve and parse all the currently available HTTP error log files.

The stdin command, used to pipe command executions, such as type HttpErrl.log|LogParser “SELECT * from stdin”-i:HTTPERR.

There are no options available for the HTTPERR input data format.

9.0 EVT

This input data format reads event information from the WINDOWS Event Log, including System, Application, Security, and custom event logs, as well as from event log backup files (EVT log files). Table 14 lists the EVT input data format field names and corresponding data types.

TABLE 14

| Field | Data Type |
|---|---|
| EventLog | STRING |
| RecordNumber | INTEGER |
| TimeGenerated | TIMESTAMP |
| TimeWritten | TIMESTAMP |
| EventID | INTEGER |
| EventType | INTEGER |
| EventTypeName | STRING |
| EventCategory | INTEGER |
| SourceName | STRING |
| Strings | STRING |
| ComputerName | STRING |
| SID | STRING |
| Message | STRING |

FROM clauses for the EVT input data format accept a comma-separated list of names of EventLog (System, Application, Security, or a custom event log) or EVT log files, optionally preceded by the name of the computer, such as \\COMPUTER2\System. For example: SELECT Message FROM System, Application, \\COMPUTER2\System, D:\MyEVTLogs\*.evt, \COMPUTER5\Security.

The following options are available for the EVT input data format:

fullText: Retrieves the full text of the event log message; legal values are ON or OFF. The default value is ON.

formatMsg: Formats the message, removing carriage returns, line feeds, and extra spaces. Legal values are ON or OFF. The default value is ON.

ignoreMsgErr: Ignores errors that occurred while retrieving the full text of the event log message. Legal values are ON or OFF. The default value is OFF. If these errors are not ignored and an error occurs while retrieving the text of the message, the entry itself is not returned. Conversely, if these errors are ignored and an error occurs while retrieving the text of the message, the entry's Message field is returned as NULL.

fullEventCode: When this option is set to ON, log parser 202 returns the full 32-bit value of the EventID code. When set to OFF, log parser 202 returns the lower 16-bit value of the code (as displayed by the Event Viewer). The default value is OFF.

resolveSIDs: Resolves all the retrieved SIDs into fully specified account names; legal values are ON or OFF. The default value is OFF.

10. TEXTWORD and TEXTLINE

These input data formats extract words and full lines from generic text files.

TEXTWORD: The Text field of this input data format is represented by any single word (separated by spaces) in the text file.

TEXTLINE: The Text field of this input data format is represented by any single line (separated by CRLF or CR) in the text file.

TEXTWORD and TEXTLINE use the same field names and corresponding data types; listed in Table 15.

TABLE 15

| Field | Data Type |
|---|---|
| LogFileName | STRING |
| Index | INTEGER |
| Text | STRING |

The TEXTWORD and TEXTLINE input data formats accept the following values in the FROM clause:

A file name or a comma-separated list of file names, including names that contain wildcards, such as D:\Files\*.txt, D:\*.log.

The stdin command, used to pipe command executions, such as type filel.txt|LogParser “SELECT * from stdin”-i:WORD.

There are two options available for the TEXTWORD and TEXTLINE input data formats.

iCodepage: Specifies the codepage in which the files are encoded; legal values are 1252, 0 (current system codepage), −1 (Unicode), 65001 (UTF-8), and so on. The default value is 0.

recurse: Specifies that the search recurses all subfolders. Legal values are ON or OFF. The default value is OFF.

11. CSV

This input data format reads CSV text files, which are text files that contain comma-separated lists of values. CSV input data format fields are determined at run time, depending on the files and the specified options, which are listed below. The CSV input data format accepts the following values in the FROM clause:

A file name or a comma-separated list of file names, including names that contain wildcards, such as D:\Files\*.csv, D:\file.csv.

The stdin command, used to pipe command executions, such as type log.csv|LogParser “SELECT * from stdin”-i:CSV.

The following options are available for the CSV input data format:

iCodepage: Specifies the codepage in which the files are encoded; legal values are 1252, 0 (current system codepage), −1 (Unicode), 65001 (UTF-8), and so on. The default value is 0.

headerRow: Specifies that the input source treats the first row of every file as a comma-separated list of field names. Legal values are ON or OFF. The default value is ON. When this option is set to OFF, the fields are named Field1, Field2, and so on.

dtLines: Specifies that the input source first reads the specified number of lines from the files, trying to detect the field types. Specifying 0 disables the search, and all the fields are treated as STRING values. The default value is 10.

tsFormat: Specifies the timestamp format used by the TIMESTAMP fields in the file. You can specify any timestamp format. The default value is yyyy-MM-dd hh:mm:ss.

To see how the fields are detected by the CSV input data format, type the following at the command line: logparser-h-i:CSV <from\-entity>. For example: logparser-h-i:CSV mycsvfile.txt

12. W3C

This input data format reads W3C format log files, which are files not specific to IIS—that contain special headers and space-separated lists of values. For example, WINDOWS Media Services, Personal Firewall, and Exchange all write log files in this format. W3C fields are determined at run time, depending on the files and the specified options, which are listed later in this section.

The W3C input data format accepts the following values in the FROM clause:

A file name or a comma-separated list of file names, including names that contain wildcards, such as D:\Files\*.log, D:\file.log.

The stdin command, used to pipe command executions, such as type extendl.log|LogParser “SELECT * from stdin”-i:W3C.

The following options are available for the W3C input data format:

iCodepage: Specifies the codepage in which the files are encoded. Legal values are 1252, 0 (current system codepage), −1 (Unicode), 65001 (UTF-8), and so on. The default value is 0.

dtLines: Specifies that the input source first reads the specified number of lines from the files, trying to detect the field types. Specifying 0 disables the search, and all the fields are treated as STRING values. The default value is 10.

dQuotes: Specifies that the STRING values in the file are enclosed in quotation marks (“ ”). Legal values are ON or OFF. The default value is OFF.

separator: Specifies the character that is considered as the separator between fields. Legal values are any single character enclosed between apostrophes, for example ‘,’ or ‘|’, or the special strings ‘tab’ and ‘space’. The default value is ‘ ’ (a space character). For example, the Exchange Tracking log files use a tab character as the separator between the fields.

To see how fields are detected by the W3C input data format, type the following at the command line: logparser-h-i:W3C<from_entity>. For example: logparser-h-i:W3C myw3cfile.txt.

13. FS

This input source reads file information from the specified path, such as file size, creation time, and file attributes. The FS input data format is similar to an advanced dir command. Table 16 lists the FS field names and corresponding data types.

TABLE 16

| Field | Data Type |
|---|---|
| Path | STRING |
| Name | STRING |
| Size | INTEGER |
| Attributes | STRING |
| CreationTime | TIMESTAMP |
| LastAccessTime | TIMESTAMP |
| LastWriteTime | TIMESTAMP |
| FileVersion | STRING |

FROM clauses for the FS input source can accept a path or a comma-separated list of paths, including paths that contain wildcards, such as D:\Files\*.txt, D:\*.*. The following option is available for the FS input source: recurse: Specifies that the search recurses all subfolders. Legal values are ON or OFF. The default value is ON.

Exemplary Log Parser Output

Log parser 202 supports the following output targets:

W3C: This format sends results to a text file that contains headers and values that are separated by spaces.

IIS: This format sends results to a text file with values separated by commas and spaces.

SQL: This format sends results to a SQL table.

Comma-Separated-Value (CSV): This format sends results to a text file. Values are separated by commas and optional tab spaces.

XML: This format sends results to an XML-formatted text file.

Template: This format sends results to a text file formatted according to a user-specified template.

Native: This format is intended for viewing results on screen.

### W3C

The W3C output format writes results to a generic W3C-format text file. At the top of the text file are W3C headers describing the fields. Field names are generated from the SELECT clause or from the aliases assigned to them. Values are separated with spaces.

When writing the TO clause with the W3C output format, you can use a single file name, or you can use the stdout command to print results directly to the screen. If you use a wildcard character (*) in the specified file name, the Multiplex feature is enabled. The Multiplex feature converts the first fields in the SELECT clause and substitutes them for the wildcards in the file name generation. For more information on Multiplex, see “Multiplex Feature” later in this document.

The following options are available for the W3C output target:

rtp: When printing to the screen, this option specifies the number of rows to print before the user is prompted to press a key to continue. If set to −1, the rows print without interruption. The default value is 10.

oCodepage: Specifies the output codepage. Legal values are 1252, 0 (current system codepage), −1 (Unicode), 65001 (UTF-8), and so on. The default value is 0.

odquotes: Specifies that STRING values should be enclosed in quotation marks (“ ”). Legal values are ON or OFF. The default value is OFF.

odirtime: Specifies a string to write to the #Date header directive. The default behavior is to write the current date and time.

filemode: Specifies the action to perform when the output file already exists. If you set the value to 0, log parser 202 appends to the existing file. If you set the value to 1, log parser 202 overwrites the existing file. If you set the value to 2, log parser 202 does not write to the file. The default value is 1: overwrite the existing file.

The following command, for example, creates a W3C-format log file (e.g., output file 208 of FIG. 2) containing some fields from the Event Log:

logparser “Select TO_DATE(TimeGenerated) as date, TO_TIME(TimeGenerated) as time, EventID as event-id, EventType as event-type, SourceName as sourcename FROM System TO exevent.log”-o:W3C.

The first lines of an exemplary generated Exevent.log file are as follows:

#Software: Log Parser
#Version: 1.0
#Date: 2002-06-21 18:26:10
#Fields: date time event-id event-type sourcename
2002-04-17 11:31:19 6008 1 EventLog
2002-04-17 11:31:19 6009 4 EventLog
2002-04-17 11:31:19 6005 4 EventLog
2002-04-17 11:30:53 10 4 redbook
2002-04-17 11:31:31 37 4 W32Time
2002-04-17 11:31:37 1101 2 SNMP
2002-04-17 11:31:37 1001 4 SNMP
2002-04-17 11:31:47 35 4 W32Time
2002-04-17 11:32:23 7035 4 Service Control Manager

### IIS

This output format writes fields according to the Microsoft IIS file format. The resulting text file contains a list of values separated by a space and comma, with no headers. When writing the TO clause with the W3C output format, you can use a single file name, or you can use the stdout command to print results directly to the screen. If you use a wildcard character (*) in the specified file name, the Multiplex feature is enabled. The Multiplex feature converts the first fields in the SELECT clause and substitutes them for the wildcards in the file name generation. For more information on Multiplex, see “Multiplex Feature” later in this document.

The following options are available for the IIS output target:

rtp: When printing to the screen, this option specifies the number of rows to print before the user is prompted to press a key to continue. If set to −1, the rows print without interruption. The default value is 10.

oCodepage: Specifies the output codepage. Legal values are 1252, 0 (current system codepage), −1 (Unicode), 65001 (UTF-8), and so on. The default value is 0.

filemode: Specifies the action to perform when the output file already exists. If you set the value to 0, log parser 202 appends to the existing file. If you set the value to 1, log parser 202 overwrites the existing file. If you set the value to 2, log parser 202 does not write to the file. The default value is 1: overwrite the existing file.

### SQL

This output format sends the results to a SQL table using the ODBC Bulk Add command. If the SQL table already exists, the SELECT clause must match the SQL table columns in type and number. In addition, the fields in the SELECT clause must appear in the same order as the SQL table columns. If the SQL table does not yet exist and the createtable option is specified, log parser 202 creates the table, deriving the column types and names from the SELECT clause. Table 17 lists the type mapping for new SQL tables.

TABLE 17

| Log Parser Type | SQL Type |
|---|---|
| INTEGER | int |
| REAL | real |
| STRING | varchar |
| TIMESTAMP | datetime |

The argument of the TO clause is the name of the table. The following options are available for the SQL output format:

server: Specifies the name of the server hosting the database.

database: Specifies the database name where the table resides.

driver: Specifies the name of the driver to use during the ODBC operation. To specify SQL Server, enclose the value in quotation marks, such as -driver:“SQL Server”.

username: User name to use when connecting to the database.

password: Password to use when connecting to the database.

dsn: Name of an optional local DSN to use for the connection.

createtable: If the target table does not exist, and this parameter is set to ON, then log parser 202 creates a table, deriving the column types and names from the SELECT clause according to the type mapping above. The default value is OFF.

cleartable: Clears the existing table before storing results. The default value is OFF.

fixcolnames: Removes illegal characters from column names for tables that log parser 202 creates. The default value is ON.

The following command exports some of the fields in a W3C log file to a SQL table:

logparser “Select TO_TIMESTAMP(date, time) as Timestamp, cs-

uri-stem as UriStem,

cs-uri-query as UriQuery FROM ex000123.log TO TestTable” -

o:SQL

-server:GABRIEGISQL -driver:“SQL Server” -database:LogDB -

username:giuseppini

-password:xxx -createtable:ON

The resulting exemplary table contains the following information:

| Timestamp | UriStem | UriQuery |
|---|---|---|
| 1/1/2002 12:00:01 | /Default.htm | <NULL> |
| 1/1/2002 12:00:03 | /default.asp | PageID=4 |
| 1/1/2002 12:00:03 | header.gif | <NULL> |

### CSV

This format writes results to a text file using the comma-separated values format. After an optional header, all values appear, separated by commas and optional spaces. When creating the TO clause with the CSV output format, you can use a single file name, or you can use the stdout command to print results directly to the screen. If you use a wildcard character (*) in the specified file name, the Multiplex feature is enabled. The Multiplex feature converts the first fields in the SELECT clause and substitutes them for the wildcards in the file name generation. For more information on Multiplex, see “Multiplex Feature” later in this document.

The following options are available for the CSV output format:

headers: Writes a first line containing the field names. The default value is ON.

tabs: Writes a tab character after every comma separator. The default value is ON.

tsformat: Specifies the timestamp format to use for TIMESTAMP values. The default value is yyyy-MM-dd hh:mm:ss.

oCodepage: Specifies the output codepage. Legal values are 1252, 0 (current system codepage), −1 (Unicode), 65001 (UTF-8), and so on. The default value is 0.

filemode: Specifies the action to perform when the output file already exists. If you set the value to 0, log parser 202 appends to the existing file. If you set the value to 1, log parser 202 overwrites the existing file. If you set the value to 2, log parser 202 does not write to the file. The default value is 1: overwrite the existing file.

The following command creates a CSV file containing information about all the files larger than 500 KB in the System32 folder:

logparser “SELECT Name, Size, Attributes FROM

C:\winnt\system32\*.* TO files.csv WHERE Size>512000” -i:FS -o:CSV

The resulting file is exemplified as follows:

| Name, | Size, | Attributes |
|---|---|---|
| adminpak.msi, | 13135360, | -A------- |
| adprop.dll, | 740864, | -A------- |
| advapi32.dll, | 546304, | -A------- |
| autochk.exe, | 573952, | -A------- |
| autoconv.exe, | 587264, | -A------- |
| autofmt.exe, | 566784, | -A------- |

### XML

The XML output format is used to write results to an XML file. The XML file is structured as a sequence of ROW elements, each containing a sequence of FIELD elements. The FIELD elements are written in four different formats, depending on the value of the STRUCTURE parameter:

When the STRUCTURE parameter has a value of “1”, the FIELD elements have the same names as the fields in the query result; for example, a ROW element looks like this: <ROW><UriStem>/default.htm</UriStem><BytesSent>242</BytesSent></ROW>.

When the STRUCTURE parameter has a value of “2”, the FIELD elements have the same names as the fields in the query result, and each element has a TYPE attribute describing the data type. For example, a ROW element looks like this: <ROW><UriStem TYPE=“STRING”>/default.htm</UriStem><BytesSent TYPE=“INTEGER”>242</BytesSent></ROW>.

When the STRUCTURE parameter has a value of “3”, the FIELD elements are named FIELD, and each element has a NAME attribute describing the name of the field; for example, a ROW element looks like this: <ROW><FIELDNAME=“UriStem”>/default.htm</FIELD><FIELD NAME=“BytesSent”>242</FIELD></ROW>.

When the STRUCTURE parameter has a value of “4”, the FIELD elements are named FIELD, and each element has a NAME attribute describing the name of the field and a TYPE attribute describing the data type. For example, a ROW element looks like this: <ROW><FIELD NAME=“UriStem” TYPE=“STRING”>/default.htm</FIELD><FIELD NAME=“BytesSent” TYPE=“INTEGER”>242</FIELD></ROW>.

The following options are available for the XML output target:

structure: Specifies the structure type of the XML document. Legal values are 1, 2, 3 and 4. The default value is 1.

rootname: Specifies the name of the ROOT element in the XML document. The default value is ROOT.

rowname: Specifies the name of the ROW element in the XML document. The default value is ROW.

fieldname: Specifies the name of the FIELD element in the XML document when the STRUCTURE parameter has a value of “2” or “3”. The default is FIELD.

xslLink: Specifies an optional link to an external XSL file to be referenced inside the XML document. The link is not specified by default.

schemaType: Type of the inline schema specification. Legal values are 0 (none) and 1 (DTD). The default value is 1.

compact: Writes the XML document suppressing carriage return/line feed, and space characters. The default value is OFF.

standAlone: Writes a fully-compliant XML document with the <XML> header and every ROW element embedded in a global ROOT element. Setting this value to OFF generates a document with no text other than the ROW elements, suitable for being concatenated with other documents. The default value is ON. Notice that setting this value to OFF generates a document not compliant to the XML specifications.

oCodepage: Specifies the output codepage. Legal values are 1252, 0 (current system codepage), −1 (Unicode), 65001 (UTF-8), and so on. The default value is 0.

filemode: Specifies the action to perform when the output file already exists. If you set the value to 0, log parser 202 appends to the existing file. If you set the value to 1, log parser 202 overwrites the existing file. If you set the value to 2, log parser 202 does not write to the file. The default value is 1: overwrite the existing file.

The following command writes an XML document containing the Url and BytesSent fields from an IIS W3C log file: logparser “SELECT cs-uri-stem as Url, sc-bytes as BytesSent from ex000805.log to Report.xml”-o:XML-structure:2,

The resulting exemplary file appears as follows:

<?xml version=“1.0” standalone=“yes”?>
<!DOCTYPE ROOT[

<!ATTLIST ROOT DATE_CREATED CDATA #REQUIRED>
<!ATTLIST ROOT CREATED_BY CDATA #REQUIRED>
<!ELEMENT Url (#PCDATA)>
<!ATTLIST Url TYPE CDATA #REQUIRED>
<!ELEMENT BytesSent (#PCDATA)>
<!ATTLIST BytesSent TYPE CDATA #REQUIRED>
<!ELEMENT ROW (Url, BytesSent)>
<!ELEMENT ROOT (ROW*)>

]>
<ROOT DATE_CREATED=“2002-11-07 22:04:54” CREATED_BY=“
Log Parser V2.0”>

<ROW>

<Url TYPE=“STRING”>
/logparser
</Url>
<BytesSent TYPE=“INTEGER”>
3890
</BytesSent>

</ROW>
<ROW>

<Url TYPE=“STRING”>
/logparser/chartquery.asp
</Url>
<BytesSent TYPE=“INTEGER”>
0
</BytesSent>

</ROW>
<ROW>

<Url TYPE=“STRING”>
/logparser/chartit.asp
</Url>
<BytesSent TYPE=“INTEGER”>
0
</BytesSent>

</ROW>

</ROOT>

### TPL

The template output target writes results according to a user-specified template file. There are two different formats in which template files can be written: raw format and structured format.

1. Raw Format

In the raw format, the template file contains the text that is output for each row. The text can contain special % fieldname % tags that are substituted at run time with the values of the specified fields. The following is a sample raw format template file called mytemplate.txt:

The Url % cs-uri-stem %, requested by % c-ip %, took % time-taken % milliseconds to execute.

It was requested at % time % o'clock.

To use the template, type the following command: LogParser “SELECT * from extend1.log to out.txt”-o:TPL-tpl:mytemplate.txt. The resulting file contains the following information:

The Url /default.htm, requested by 192.141.56.132,
took 24 milliseconds to execute.
It was requested at 04:23:45 o'clock.
The Url /mydocuments/index.html, requested by
192.141.56.133, took 134 milliseconds to execute.
It was requested at 04:23:47 o'clock.

In addition, one can include the optional TPLHEADER and TPLFOOTER parameters to specify that a header is written at the beginning, and a footer is written at the end of the output file.

2.0 Structured Format

In the structured format, the template file contains <LPBODY> and </LPBODY> tags, which enclose the text that is output for each row. Optional <LPHEADER> and </LPHEADER> tags enclose header text. Any text outside these tags is considered comment text and are ignored by Log Parser. The BODY section can contain special % fieldname % tags that are substituted at run time with the values of the specified fields. At the end of the BODY section are optional <LPFOOTER> and </LPFOOTER> tags that enclose the footer text. The following is a sample structured format template file called mytemplate.txt:

<LPHEADER>This is my template. </LPHEADER>
Some comment here.
<LPBODY>The Url %cs-uri-stem%, requested by %c-ip%, took %time-
taken% milliseconds to execute.
It was requested at %time% o'clock.
</LPBODY>
<LPFOOTER>End of report.
</LPFOOTER>

To use this template, type the following command: LogParser “SELECT * from extend1.log to out.txt”-o:TPL-tpl:mytemplate.txt. The resulting file contains the following information:

This is my template.
The Url /default.htm, requested by 192.141.56.132,
took 24 milliseconds to execute.
It was requested at 04:23:45 o'clock.
The Url /mydocuments/index.html, requested by
192.141.56.133, took 134 milliseconds to execute.
It was requested at 04:23:47 o'clock.
End of report.

If one uses the TPLHEADER and TPLFOOTER parameters to specify a header or footer file, these override the header and footer text placed in the template. Note: In this implementation, the log parser 202 assumes that the character immediately following the opening tag for a section, such as <LPBODY>, belongs to that section

The following options are available for the TPL output target:

tpl: Specifies the path to the template file.

tplheader: Specifies the path to an optional header file.

tplfooter: Specifies the path to an optional footer file.

oCodepage: Specifies the output codepage. Legal values are 1252, 0 (current system codepage), −1 (Unicode), 65001 (UTF-8), and so on. The default value is 0.

filemode: Specifies the action to perform when the output file already exists. If you set the value to 0, log parser 202 appends to the existing file. If you set the value to 1, log parser 202 overwrites the existing file. If you set the value to 2, log parser 202 does not write to the file. The default value is 1: overwrite the existing file.

3.0 NAT

The Log Parser Native output format is intended to show results on screen. If you want to write results to a file, you can use a single file name as the argument of the TO clause. Use the stdout command to print directly to the screen. If no TO clause is specified, log parser 202 prints to the screen. The following options are available for the NAT output format:

rtp: When printing to the screen, this option specifies the number of rows to print before the user is prompted to press a key to continue. If set to −1, the rows print without interruption. The default value is 10.

headers: Writes a header line containing the field names every time a new screen group is printed. The default value is ON.

spacecol: Spaces all the fields in the same screen group equally. The default value is ON.

ralign: When set to ON, the fields are right aligned. The default value is OFF.

colsep: Specifies the character to use when spacing the fields. Default value is a space.

oCodepage: Specifies the output codepage. Legal values are 1252, 0 (current system codepage), −1 (Unicode), 65001 (UTF-8), and so on. The default value is 0.

filemode: Specifies the action to perform when the output file already exists. If you set the value to 0, log parser 202 appends to the existing file. If you set the value to 1, log parser 202 overwrites the existing file. If you set the value to 2, log parser 202 does not write to the file. The default value is 1: overwrite the existing file.

The following command prints to the screen all the URLs hit on your server running IIS, together with the error response status code: logparser “SELECT cs-uri-stem, sc-status FROM <1> WHERE sc-status>=400”. The resulting screen lists, for example, the following values:

| cs-uri-stem | sc-status |
|---|---|
| /scripts/..^{L}>>../winnt/system32/cmd.exe | 404 |
| /scripts/..^{⊥}£../winnt/system32/cmd.exe | 404 |
| /scripts/..%5c../winnt/system32/cmd.exe | 404 |
| /scripts/..%5c../winnt/system32/cmd.exe | 404 |
| /scripts/..%5c../winnt/system32/cmd.exe | 404 |
| /scripts/..%2f../winnt/system32/cmd.exe | 404 |
| /scripts/root.exe | 404 |
| /MSADC/root.exe | 404 |
| /c/winnt/system32/cmd.exe | 404 |
| /d/winnt/system32/cmd.exe | 404 |
| Press a key... | 404 |

An Exemplary Multiplex Feature

For most output targets, wildcards in the target file path automatically enable the Multiplex feature. Multiplex converts the first fields in the SELECT statement to strings and substitutes them for the wildcards in the file path generation. These fields are not output as results. For example, if you want to write all the event log messages to different files according to the event source, type the following command:

logparser “SELECT SourceName, Message FROM System TO eventlogs\*.txt where EventTypeName=‘Error event’”-i:EVT-o:CSV The values of the SourceName field are substituted for the wildcard character (*) in the output file name, and the Message field alone is output. The query results in formulation of files, containing the messages from the system event log, look for example, as follows:

| 06/20/2002 05:07 PM | | <DIR> | . |
|---|---|---|---|
| 06/20/2002 05:07 PM | | <DIR> | .. |
| 06/20/2002 05:07 PM | | 223,001 | BROWSER.txt |
| 06/20/2002 05:07 PM | | 3,957 | Cdrom.txt |
| 06/20/2002 05:07 PM | | 35,425 | DCOM.txt |
| 06/20/2002 05:07 PM | | 192 | Dhcp.txt |
| 06/20/2002 05:07 PM | | 2,078 | EventLog.txt |
| 06/20/2002 05:07 PM | | 292 | IIS Config.txt |
| 06/20/2002 05:07 PM | | 9,826 | Kerberos.txt |
| 06/20/2002 05:07 PM | | 13,113 | LsaSrv.txt |
| 06/20/2002 05:07 PM | | 765 | MRxSmb.txt |
| 06/20/2002 05:07 PM | | 81 | NetBT.txt |
| 06/20/2002 05:07 PM | | 5,717 | NETLOGON.txt |
| 06/20/2002 05:07 PM | | 837 | nv4.txt |
| 06/20/2002 05:07 PM | | 4,293 | Server.txt |
| 06/20/2002 05:07 PM | | 8,422 | Service Control Manager.txt |
| 06/20/2002 05:07 PM | | 158 | Setup.txt |
| 06/20/2002 05:07 PM | | 266 | SideBySide.txt |
| 06/20/2002 05:07 PM | | 330 | System Error.txt |
| 06/20/2002 05:07 PM | | 856 | TermDD.txt |
| 06/20/2002 05:07 PM | | 1,066 | TermServDevices.txt |
| 06/20/2002 05:07 PM | | 9,148 | W32Time.txt |
| 06/20/2002 05:07 PM | | 1,341 | W3SVC.txt |
| | 21 File(s) | 321,164 | bytes |

The following example converts IIS binary log files, each of which contain entries for all sites on a server, to the W3C Extended log format structure. The result is separate sets of files, each in a folder identified by Site ID, with files separated according to the date the requests were received.

logparser “SELECT SiteID,TO_STRING(DateTime,“yyMMdd”),
TO_DATE(DateTime) AS date, TO_TIME(DateTime) AS time, UriStem
AS cs-uri-stem FROM ra*.ibl TO W3SVC*\ex*.log” -i:BIN -o:W3C

The first two fields (SiteID and the log entry timestamp formatted as “yyMMdd”) are substituted for the two wildcards in the target file name, and the folders and file names are created accordingly. The result is similar to the following exemplary structure:

W3SVC1\

ex020618.log

ex020619.log

ex020620.log

W3SVC2\

ex020618.log

ex020620.log

W3SVC3\

ex020618.log

ex020619.log

ex020621.log

Exemplary Log File Format Conversions

When using log parser 202 to convert one log file format to another, pay close attention to the order and names of the fields in the input and output formats. Some output formats, such as the IIS log format, have fixed fields. When converting to IIS log format, select fields from the input data format that match the IIS format. For example, when converting a W3C Extended log file to IIS log format, select the client IP address first, the user name next, and so on.

In addition, you might want to change the name of the fields that you extract from the input data format. For example, when writing to an IIS W3C Extended format log file, log parser 202 retrieves the names to be written in the “#Fields” directive from the SELECT statement. If you retrieve data from an IIS log format file, these names are not the same as those used by the W3C Extended format, so use the AS statement for every field in order to get the correct field name.

Consider the following built-in log parser 202 conversion query that converts IIS log format files to IIS W3C Extended log format:

SELECT TO_DATE(TO_UTCTIME(TO_TIMESTAMP(Date,
Time))) as
date, TO_TIME( TO_UTCTIME( TO_TIMESTAMP(Date,
Time))) as
time, ServiceInstance as s-sitename, HostName as s-computername,
ServerIP as s-ip, RequestType as cs-method, REPLACE_CHR(Target, ‘
\u0009\u000a\u000d’, ‘+’)
as cs-uri-stem, Parameters as cs-uri-query,
UserName as cs-username, UserIP as c-ip, StatusCode as sc-status,
Win32StatusCode as sc-win32-status, BytesSent as sc-bytes,
BytesReceived as cs-bytes, TimeTaken as time-taken

Notice that the individual fields have been renamed according to the IIS W3C Extended convention, so that the output file is fully compliant with the IIS W3C Extended format. In addition, the date and time fields are converted from local time, which is used in the IIS log format, to UTC time, which is used in the IIS W3C Extended log format.

Exemplary Log Parser Command-Line Architecture

Log parser 202 is available as a command-line tool, LogParser.exe, which has three operational modes:

Standard: In standard mode, you specify the input data format, query, and output format, as well as other global parameters.

Conversion: In conversion mode, you specify the input data format, output target, and an optional WHERE clause, and log parser 202 generates a query automatically. Conversion mode is for converting one log file format to another.

Help: In Help mode, log parser 202 displays information about how to use the tool.

### Standard Mode

In standard mode, you specify the input data format and its parameters, the output format and its parameters, the SQL query, and other global parameters. Standard mode is the default. The following example lists the syntax for standard mode:

LogParser [-i:<input_format>] [-o:<output_format>]

<SQL query> | file:<query_filename>
[<input_format_options>] [<output_format_options>]
[-q[:ON|OFF]] [-e:<max_errors>] [-iw[:ON|OFF]]
[-stats[:ON|OFF]].

Table 18 lists the parameters used in a standard mode query.

TABLE 18

| Parameter | Description |
|---|---|
| -i:<input_format> | IISW3C, NCSA, IIS, ODBC, BIN, |
| | IISMSID, HTTPERR, URLSCAN, |
| | CSV, W3C, EVT, TEXTLINE, |
| | TEXTWORD, FS. |
| <input_format_options> | Options specific to the input data |
| | format selected. |
| -o:<output_format> | CSV, XML, NAT, W3C, IIS, SQL, |
| | TPL. |
| <output_format_options> | Options specific to the |
| | output format selected. |
| -e:<max_errors> | Maximum number of parse |
| | errors before aborting. Default is −1 |
| | (ignore all). |
| -iw[:ON\|OFF] | Ignore warnings. Default is |
| | OFF. |
| -stats[:ONOFF] | Dump statistics after |
| | executing query. Default is |
| | ON. |
| -q[:ON\|OFF] | Quiet mode. Quiet mode runs with |
| | the following settings: No statistics, |
| | max_errors = −1, |
| | iw = ON, and appropriate settings for |
| | the NAT |
| | output format; suitable for |
| | exporting the |
| | results to another application. |
| | Default is OFF. |

In standard mode, if you do not specify an input data format, log parser 202 tries to determine the format based on the FROM clause. For example, if the FROM clause is FROM extend*.log, then log parser 202 uses IIS W3C Extended log file input data format because files in this format are commonly named Extend1.log. The same applies to the output target. If, for example, you specify file.csv as the file to which log parser 202 writes results, then log parser 202 automatically uses the CSV output target.

If you do not specify the input data format and log parser 202 cannot determine it, the TEXTLINE input source is used. If you do not specify the output target and log parser 202 cannot determine it, the NAT output target is used.

### Standard Mode Examples

The following example exports data from W3C Extended log files and writes it to a SQL table:

logparser “Select TO_TIMESTAMP
(date, time) as Timestamp,
cs-uri-stem as UriStem, cs-uri-query
as UriQuery FROM ex000123.log TO
TestTable” -i:W3C
-o:SQL -server:GABRIEGISQL
-driver: “SQL Server”
-database:LogDB -username:user
-password:xxx -createtable:ON.

The following example retrieves a list of the largest files on the root of a D: drive and prints the results to the screen:

logparser ”Select Name, Size FROM D:\*.* ORDER BY Size
DESC”
-i:FS -recurse:OFF

Exemplary Conversion Mode

In conversion mode, you specify the input data format and output format, the input file or files and the output file, and an optional filtering WHERE clause. To activate conversion mode, type-c. The following example lists the syntax for conversion mode:

LogParser -c -i:<input_format> -o:<output_format> <from_entity>

<to_entity> [<where_clause>] [<input_format_options>]
[<output_format_options>] [-multisite[:ON|OFF]
[-q[:ON|OFF]] [-e:<max_errors>] [-iw[:ON|OFF]]
[-stats[:ON|OFF]]

-multisite[:ON|OFF] : send BIN conversion output to multiple files

depending on the SiteID value. The
<to_entity> filename must contain 1 wildcard.
Default is OFF.

In conversion mode, log parser 202 automatically generates SQL queries using standard built-in queries. Table 19 lists exemplary input data format and output target pairs for which log parser 202 can run a standard conversion query.

TABLE 19

| Input data format | Output Format |
|---|---|
| BIN | W3C |
| IIS | W3C |
| IISMSID | W3C |
| BIN | IIS |
| W3C | IIS |
| W3C | IISMSID |

To convert error hits in an IIS log file to W3C Extended log format, type the following: logparser-c-i:IIS-o:W3C in 010322.log ex010322.log “StatusCode>=400”.

### Multiplex in Conversion Mode

If you specify the -multisite option during a conversion from the IIS binary log file format (BIN) input data format to any other format, and if the <to_entity> file name contains one wildcard, then the generated SQL query specifies the SiteID field as its first value, in order to multiplex the converted records to different files or folders according to the SiteID field.

For example, to convert a single IIS binary log file into several W3C Extended format log files, each in its site-identified folder, use the following command: logparser-c-i:BIN-o:W3C ra020604.ibl W3SVC*\ex020604.log-multisite:ON.

Exemplary Help Mode

When you execute log parser 202 without any argument, you are presented with the Usage Help screen. To use Help mode to retrieve the names and types of the fields for the IISW3C input source, type: logparser-h-i:IISW3C. If the input data format requires a FROM clause to determine field names and types, such as CSV and W3C, you can specify the target of the FROM clause: logparser-h-i:W3C myw3cfile.log.

An Exemplary Procedure

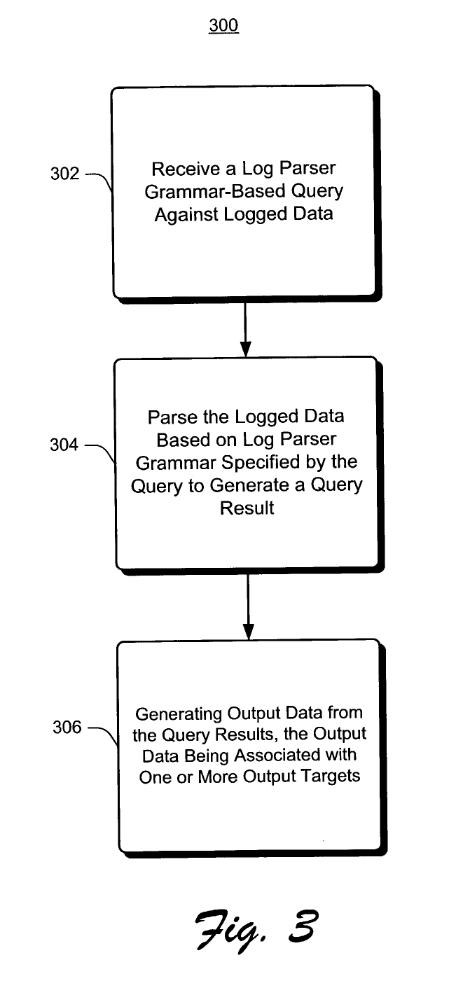

FIG. 3 shows an exemplary procedure 300 for log parser. The operations of the procedure 300 are implemented by the log parser 202 of FIG. 2. Or, as discussed in greater detail below in the section titled “alternate embodiments”, the operations of the procedure are implemented by objects exposed by the log parser common library 220 (FIG. 2). In particular, at block 302, the procedure receives a log parser grammar-based query 206 (FIG. 2) to run/execute with respect to a log file 208. At block 304, and responsive to receiving the query, the query engine 210 (FIG. 2) parses the query to generate query result(s) 212 (FIG. 2), which represent the desired/queried-for information. At block 306, the log parser generates output data 214 (FIG. 2) from the query results. The output data can be associated with any number of specified targets. For instance, the output data may be presented to an end-user (e.g., via the display monitor 146 of FIG. 1), written to one or more database tables, and/or written into data file(s) of specified data format, etc.

Exemplary LP Grammar-Based Log Queries

The query 204 below is run against an IIS W3C Extended log file 208. The query opens all the files matching ex*.log, and it writes to the MyTable SQL table all the entries that match the fields in the SELECT statement (time, client machine name, uri-stem, uri-query, and HTTP status) that satisfy the condition in the WHERE clause, and it orders them according to the time field: “SELECT time, REVERSEDNS(c-ip), cs-uri-stem, cs-uri-query, sc-status FROM ex*.log TO MyTable WHERE sc-status < >4040R time-taken>30 ORDER BY time”.

The following query 204 is run against the WINDOWS Event Log 208. It opens the Application log 208, finds all events that have more than two messages, and displays the messages on screen for only those events. “SELECT Message, COUNT(*) AS TotalCount FROM Application GROUP BY Message HAVING TotalCount>2”.

The following query 204 can be run against any text file 208. It opens all text files 208 in the D: drive, finds distinct instances of the specified text string, and writes it to the myStats.txt file: “SELECT DISTINCT STRLEN(Text) FROM D:\*.txt TO myStats.txt WHERE Text LIKE ‘% Hello World %’”.

The following query 204 computes the average IIS processing time for any single extension: “SELECT SUBSTR(cs-uri-stem, SUM(LAST_INDEX_OF(cs-uri-stem, ‘.’), 1)) AS Extension, AVG(time-taken) FROM ex*.log GROUP BY Extension”.

The following query 204 computes how many times any single word appears in the specified text file 208: “SELECT Text, COUNT(*) FROM file.txt GROUP BY Text HAVING COUNT(*)>1 ORDER BY COUNT(*) DESC”-i:TEXTWORD.

The following query 204 computes the number of requests the server receives for every 30-minute interval: “SELECT QUANTIZE(TO_TIMESTAMP(date, time), 1800) as Hours, COUNT(*) FROM <1> GROUP BY Hours ORDER BY Hours”.

The following query 204 retrieves all user names connecting to the server: “SELECT DISTINCT cs-username FROM <1>”.

The following query 204 creates an XML file containing the Web server's 100 most requested URLs. It links to an external XSL file that formats the output as HTML: “SELECT TOP 100 STRCAT(cs-uri-stem, REPLACE_IF_NOT_NULL(cs-uri-query, STRCAT(‘?’,cs-uri-query))) AS Request, COUNT(*) AS HitCounter FROM <1> TO out.xml GROUP BY Request ORDER BY Request DESC”-o:XML-xsllink:/myXSLs/xsl_format.xsl.

The following query 204 stores all the “Application Hang” event log messages to a SQL table: “SELECT Message FROM Application TO mySqlTable WHERE SourceName=‘Application Hang’”.

The following query 204 retrieves a listing of the largest files on the D: drive: “SELECT Path, QUANTIZE(Size, 1000000) AS Megs FROM D:\*.* WHERE Megs>0 ORDER BY Megs DESC”-i:FS.

In addition, most of the log parser 202 supported output targets 212 support the described Multiplex feature, which enables log parser to write results to different files depending on the first values in the SELECT clause. For example, you can multiplex an IIS log file 208 to different files 212 according to the client IP address. This query 204 creates different output files according to the value of the c-ip field, so a resulting file might be: Exclient192.81.34.156.log. “SELECT c-ip, date, time, cs-uri-stem, cs-uri-query FROM ex*.log TO exclient*.log”.

Alternate Embodiments

Referring to FIG. 2, the log parser 202 has been described above as a binary executable that in conjunction with an OS and runtime services provides the log parsing of procedure 300 to an end-user (e.g., a system administrator). These capabilities are provided via any one of multiple possible user interfaces, such as via a command line, graphical, voice controlled, or other types of user interface(s) as provided by the user input interface 144 of FIG. 1. However, in a different implementation, the described operations 300 of the log parser 202 are provided by a Log Parser Common Library (LPCL) 220 through one or more COM objects. Capabilities of the LPCL COM objects are exposed via the Log Parser API (LPAPI) 222. This enables third-party client applications (see, “other applications 204) to interface with the objects to implement the described log parsing functionalities as part of their respective implementations. For purposes of discussion, this alternate embodiment is referred to as the “Log Parser COM Architecture”.

In this implementation, the LPCL 220 objects include the following:

### MSUtil.LogOuery

MSUtil.LogQuery is the main Log Parser object (i.e., LPCL 220 object). Table 20 lists exemplary MSUtil.LogQuery methods and properties.

TABLE 20

| Method or Property | Description |
|---|---|
| ILogRecordset Execute(BSTR | This method executes the specified |
| szQuery [, InputSource]) | SQL-type query. If InputSource is |
| | not specified, the LogQuery object |
| ILogRecordset Execute(BSTR | This method executes the specified |
| szQuery [, InputSource]) | SQL-type query. If InputSource is |
| | not specified, the LogQuery object |
| | tries to determine what |
| | InputSource to use based on the |
| | FROM statement. The method |
| | returns a LogRecordset object. |
| BOOL ExecuteBatch(BSTR | This method executes the specified |
| szQuery, InputSource, | query using the specified |
| OutputTarget) | InputSource and writes the results |
| | to the specified OutputTarget. The |
| | method returns false if no error |
| | occurred. |
| int maxParseErrors | This property specifies the |
| | maximum number of parsing errors |
| | that can be encountered before |
| | throwing an exception. The default |
| | value is −1, which ignores all parse |
| | errors. |
| int lastError | This read-only property is set to a |
| | value other than 0 every time an |
| | error or a warning occurs. |
| int inputUnitsProcessed | This read-only property returns the |
| | total number or input units |
| | processed during a batch execution. |
| int outputUnitsProcessed | This read-only property returns the |
| | total number of units output during a |
| | batch execution. |
| Collection errorMessages | This read-only property returns a |
| | collection containing all the errors |
| | and warnings that occurred during |
| | execution. |

### LogRecordset

The LogRecordset object is returned by the LogQuery::Execute( . . . ) method, and it is used to walk through the records returned by the query. Table 21 lists exemplary methods and properties for the LogRecordset object.

TABLE 21

| Method or Property | Description |
|---|---|
| ILogRecord getRecord ( ) | This method returns the current |
| | record as a LogRecord object. |
| moveNext ( ) | This method advances the |
| | current record position. |
| BOOL atEnd ( ) | This method returns TRUE |
| | when there are no more records |
| | to be returned. |
| close ( ) | This method closes the recordset |
| | and frees the associated |
| | resources. |
| int getColumnCount ( ) | This method returns the total |
| | number of columns in the |
| | record. |
| BSTR getColumnName (int index) | This method returns the name of |
| | the column at the specified 0- |
| | based index. |
| int getColumnType (int index) | This method returns the type of |
| | the column at the specified 0- |
| | based index, as one of the values |
| | returned by the |
| | STRING_TYPE, |
| | INTEGER_TYPE, |
| | REAL_TYPE, or |
| | TIMESTAMP_TYPE |
| | properties. |
| int lastError | This read-only property is set to |
| | a value other than 0 every time |
| | an error or a warning occurs. |
| int inputUnitsProcessed | This read-only property returns |
| | the total number of input units |
| | processed so far. |
| Collection errorMessages | This read-only property returns |
| | a collection containing all the |
| | errors and warnings that |
| | occurred during execution. |
| STRING_TYPE, INTEGER_TYPE, | These read-only properties |
| REAL_TYPE, TIMESTAMP_TYPE | return constant values for the |
| | column types returned by the |
| | getColumnType( . . . ). method |

### LogRecord

The LogRecord object is returned by the LogRecordSet::getRecord( ) method, and it contains all the fields of a single record returned by the query. Table 22 lists the methods and properties for the LogRecord object.

TABLE 22

| Method or Property | Description |
|---|---|
| VARIANT getValue (int index) | This method returns a |
| | VARIANT holding the value at |
| | the specified column. Mapping |
| | of SQL-like types to |
| | VARIANT types is as follows: |
| | 1. INTEGER VT_I4 |
| | 2. REAL VT_R8 |
| | 3. STRING VT_BSTR |
| | 4. TIMESTAMP VT_DATE |
| BOOL isNull (int index) | This method returns TRUE if |
| | the value at the specified |
| | column is NULL. |
| BSTR toNativeString( | If the argument is a BSTR, this |
| VARIANT | method returns a BSTR created |
| separatorOrColumnIndex) | by concatenating all the values |
| | in the record converted to their |
| | native string representation and |
| | separated by the value of the |
| | argument. If the argument is an |
| | integer, the method returns a |
| | BSTR containing the native |
| | representation of the value at |
| | the specified column. |

### Input/Output Objects

The Log Parser COM architecture (i.e., a combination of a client application (see “other applications” 204 of FIG. 2) and LPCL 220 objects) uses objects that are representations of the implemented input sources and output targets. You can instantiate these objects and pass them as arguments of the ILogQuery::Execute( . . . ) and ILogQuery::ExecuteBatch( . . . ) methods. Each of the objects has properties corresponding to those available at the command line. If you need to specify properties of the input sources, instantiate the input source object, set its properties, and pass it as an argument of the ILogQuery::Execute( . . . ) or ILogQuery::ExecuteBatch( . . . ) methods.

Exemplary input/output objects include, for instance:

MSUtil.LogQuery.IISW3CInputFormat

MSUtil.LogQuery.IISNCSAInputFormat

MSUtil.LogQuery.IISIISlnputFormat

MSUtil.LogQuery.IISODBCInputFormat

MSUtil.LogQuery.IISBINInputFormat

MSUtil.LogQuery.IISIISMSIDInputFormat

MSUtil.LogQuery.URLScanLogInputFormat

MSUtil.LogQuery.EventLogInputFormat

MSUtil.LogQuery.TextWordInputFormat

MSUtil.LogQuery.TextLineInputFormat

MSUtil.LogQuery.FileSystemInputFormat

MSUtil.LogQuery.W3CInputFormat

MSUtil.LogQuery.CSVInputFormat

MSUtil.LogQuery.NativeOutputFormat

MSUtil.LogQuery.W3COutputFormat

MSUtil.LogQuery.IISOutputFormat

MSUtil.LogQuery.SQLOutputFormat

MSUtil.LogQuery.CSVOutputFormat

MSUtil.LogQuery.XMLOutputFormat

MSUtil.LogQuery.TemplateOutput Format

### Log Parser COM Architecture Script Samples

The following script sample prints the fields of an IIS W3C log file to the screen:

var logQuery=new ActiveXObject(“MSUtil.LogQuery”);
var recordSet=logQuery.Execute(“SELECT * FROM <1>”);
for(; !recordSet.atEnd( ); recordSet.moveNext( ))
{

var record=recordSet.getRecord( );
for(var col=0; col<recordSet.getColumnCount( ); col++)
{

if(record.isNull(col))

WScript.Echo(“NULL”);

else

WScript.Echo(record.getValue(col));

}

}

The following script sample prints the first column values of a CSV file that has no headers:

var logQuery=new ActiveXObject(“MSUtil.LogQuery”);
var csvInputFormat=new
ActiveXObject(“MSUtil.LogQuery.CSVInputFormat”);
csvInputFormat.headerRow=false;
var recordSet=logQuery.Execute(“SELECT * FROM file.csv”,
csvInputFormat);
for(; !recordSet.atEnd( ); recordSet.moveNext( ))
{

var record=recordSet.getRecord( );
if(record.isNull(0))

WScript.Echo(“NULL”);

else

WScript.Echo(record.toNativeString(0));

}

The following script sample generates a CSV text file using values from the System Event Log:

var logQuery=new ActiveXObject(“MSUtil.LogQuery”);
logQuery.maxParseErrors=5000; //Allow up to 5000 errors
var eventLogInputFormat=new
ActiveXObject(“MSUtil.LogQuery.EventLogInputFormat”);
var csvOutputFormat=new
ActiveXObject(“MSUtil.LogQuery.CSVOutputFormat”);
if(!logQuery.ExecuteBatch(“SELECT EventID,
SourceName FROM System to
file.csv”, eventLogInputFormat, csvOutputFormat))
{

WScript.Echo(“Completed succesfully”);

}
else
{

WScript.Echo(“Completed with the following errors:”);

var errors=new Enumerator(logQuery.errorMessages);
for(; !errors.atEnd( ); errors.moveNext( ))
{

WScript.Echo(“ERROR:” + errors.Item( ));

}
}

### CONCLUSION

The described systems 100 (FIG. 1) and methods 300 (FIG. 3) provide a log parser 202 (FIG. 2) and/or a log parser common library 222 for integration with one or more client applications (see, “other applications” 204). Although the systems and methods have been described in language specific to structural features and methodological operations, the subject matter as defined in the appended claims are not necessarily limited to the specific features or operations described. Rather, the specific features and operations are disclosed as exemplary forms of implementing the claimed subject matter.

1. A method for parsing an activity log, the method comprising:
receiving a query against logged data, the query being based on log parser grammar designed to parse activity logs of multiple different data formats;
parsing, via the query, the logged data to generate query results; and
creating output data from the query results.

2. A method as recited in claim 1, wherein the query specifies a function selected from any combination of QUANTIZE, REVERSEDNS, URLESCAPE, URLUNESCAPE, EXTRACT_VALUE, WIN32_ERROR_DESCRIPTION, Extract_token, and/or resolve_SID functions.

3. A method as recited in claim 1, wherein receiving, parsing, and creating are performed via a command line interface to an executable or via an Application Programming Interface to a library.

4. A method as recited in claim 1, wherein features of the query, parsing, query results, and output data are specified by a script.

5. A method as recited in claim 1:
wherein the logged data is in any one multiple possible data formats comprising IIS W3C Extended, IIS, IISMSID, NCSA, ODBC, BIN, URLSCAN, HTTPERR, EVT, TEXTWORD, TEXTLINE, CSV, W3C, or FS;
wherein the output data is created in any one multiple possible data formats comprising IIS W3C Extended, IIS, SQL, CSV, user specified raw or structured template, or log parser native output data format; and
wherein logged data format is independent of query result data format.

6. A method as recited in claim 1, wherein the query specifies an Active Directory Service Interface (ADSI) path, and/or indicates a virtual site or site name that hosts the logged data.

7. A method as recited in claim 1, wherein parsing the logged data further comprises one or more of extracting, filtering, searching, grouping, data mining, and/or ordering with respect to one or more entries or patterns in the logged data.

8. A method as recited in claim 1, wherein creating the output data further comprises converting the query results from one data format to a different data format.

9. A method as recited in claim 1, wherein the query indicates a multiplex feature and wherein creating the output data further comprises:
substituting strings associated with a first portion of the query for one or more wildcards in a file path generation portion of the query;
formulating the output data such that it comprises at least one file for each event source as a function of substituting the strings; and
wherein the wildcards indicate the multiplex feature.

10. A method as recited in claim 1, wherein creating the output data further comprises exporting at least a portion of the output data into one or more database tables in a database such as an SQL database.

11. A computer-readable medium comprising computer-program instructions for a log parser, the computer-program instructions being executable by a processor and comprising instructions for performing a method as recited in claim 1.

12. A computer-readable medium comprising computer-program instructions for a log parser, the computer-program instructions being executable by a processor and comprising instructions for:
querying logged data with a query derived from a log parser grammar, the log parser grammar specifying one or more functions to implement with respect to entries or data patterns in one or more activity logs of multiple possible different data formats, the logged data corresponding to at least one activity log of the activity logs;
responsive to the query, generating query results from the one or more functions; and
creating output data corresponding from the query results.

13. A computer-readable medium as recited in claim 12, wherein the one or more functions comprise any combination of QUANTIZE, REVERSEDNS, URLESCAPE, URLUNESCAPE, EXTRACT_VALUE, WIN32_ERROR_DESCRIPTION, EXTRACT_TOKEN, and/or RESOLVE_SID functions.

14. A computer-readable medium as recited in claim 12, wherein the instructions for querying, generating, and outputting are provided via a command line interface to an executable or via an Application Programming Interface to a library.

15. A computer-readable medium as recited in claim 12:
wherein the logged data is in any one multiple possible data formats comprising IIS W3C Extended, IIS, IISMSID, NCSA, ODBC, BIN, URLSCAN, HTTPERR, EVT, TEXTWORD, TEXTLINE, CSV, W3C, or FS;
wherein the output data are in any one multiple possible data formats comprising IIS W3C Extended, IIS, SQL, CSV, user specified raw or structured template, or log parser native output data format; and
wherein logged data format is independent of query result data format.

16. A computer-readable medium as recited in claim 12, wherein the query specifies an Active Directory Service Interface (ADSI) path, and/or indicates a virtual site or site name that hosts the logged data.

17. A computer-readable medium as recited in claim 12, wherein the instructions for creating the output data further comprise instructions for converting at least a subset of the logged data, via the query results, from one data format to a different data format.

18. A computer-readable medium as recited in claim 12, wherein the query indicates a multiplex feature and wherein the instructions for creating the output data further comprise instructions for:
substituting strings associated with a first portion of the query for one or more wildcards in a file path generation portion of the query;
formulating the output data such that it comprises at least one file for each event source as a function of substituting the strings; and
wherein the wildcards indicate the multiplex feature.

19. A computer-readable medium as recited in claim 12, wherein the instructions for creating the output data further comprise instructions for exporting at least a portion of the logged data into one or more database tables in a database such as an SQL database.

20. A computing device for a log parser, the computing device comprising a processor and a memory coupled to the processor, the memory comprising computer-program instructions as recited in claim 12.

21. A computing device to parse an activity log, the computing device comprising a processor and a memory coupled to the processor, the memory comprising computer-program instructions for:
generating a query as a function of log parser grammar;
asserting the query against logged data from one or more activity logs of multiple possible different data formats;
responsive to asserting the query, implementing one or more functions with respect to the logged data to generate query results, the one or more functions being specified by the query; and
creating output data from the query results, the output data being created in one or more of multiple possible different output data formats that is/are independent of one or more of multiple possible different logged data data formats.

22. A computing device as recited in claim 21, wherein the one or more functions comprises any combination of QUANTIZE, REVERSEDNS, URLESCAPE, URLUNESCAPE, EXTRACT_VALUE, WIN32_ERROR_DESCRIPTION, EXTRACT_TOKEN, and/or RESOLVE_SID functions.

23. A computing device as recited in claim 21, wherein the instructions for generating, asserting, implementing, and creating are specified via a command line interface to an executable or via an Application Programming Interface to a library.

24. A computing device as recited in claim 21:
wherein the logged data is in any one multiple possible data formats comprising IIS W3C Extended, IIS, IISMSID, NCSA, ODBC, BIN, URLSCAN, HTTPERR, EVT, TEXTWORD, TEXTLINE, CSV, W3C, or FS;
wherein the output data are in any one multiple possible data formats comprising IIS W3C Extended, IIS, SQL, CSV, user specified raw or structured template, or log parser native output data format.

25. A computing device as recited in claim 21, wherein the query specifies an Active Directory Service Interface (ADSI) path, and/or indicates a virtual site or site name that hosts the logged data.

26. A computing device as recited in claim 21, wherein the instructions for creating the output data further comprise instructions for converting at least a subset of the logged data, via the query results, from one data format to a different data format.

27. A computing device as recited in claim 21, wherein the query indicates a multiplex feature and wherein the instructions for creating the output data further comprise instructions for:
substituting strings associated with a first portion of the query for one or more wildcards in a file path generation portion of the query;
formulating the output data such that it comprises at least one file for each event source as a function of substituting the strings; and
wherein the wildcards indicate the multiplex feature.

28. A computing device as recited in claim 21, wherein the instructions for creating the output data further comprise instructions for exporting at least a portion of the logged data into one or more database tables in a database such as an SQL database.

29. A computing device for a log parser, the computing device comprising:
means for receiving a query against logged data, the query being based on log parser grammar designed to parse activity logs of multiple different data formats;
means for parsing the logged data as a function of log parser grammar specified by the query to generate query results; and
means for outputting the query results.

30. A computing device as recited in claim 29:
wherein the logged data is in any one multiple possible data formats comprising IIS W3C Extended, IIS, IISMSID, NCSA, ODBC, BIN, URLSCAN, HTTPERR, EVT, TEXTWORD, TEXTLINE, CSV, W3C, or FS;
wherein the query results are in any one multiple possible data formats comprising IIS W3C Extended, IIS, SQL, CSV, user specified raw or structured template, or log parser native output data format; and
wherein logged data format is independent of query result data format.

31. A computing device as recited in claim 29, wherein the query specifies an Active Directory Service Interface (ADSI) path, and/or indicates a virtual site or site name that hosts the logged data.

32. A computing device as recited in claim 29, wherein the means for parsing the logged data further comprise means for one or more of extracting, filtering, searching, grouping, data mining, and/or ordering with respect to one or more entries or patterns in the logged data.

33. A computing device as recited in claim 29, wherein the means for parsing the logged data further comprise means for converting the logged data from one data format to a different data format.

34. A computing device as recited in claim 29, wherein the query indicates a multiplex feature and wherein the means for parsing the logged data further comprise:
means for substituting strings associated with a first portion of the query for one or more wildcards in a file path generation portion of the query;
means for formulating the query response such that it comprises at least one file for each event source as a function of substituting the strings; and
wherein the wildcards indicate the multiplex feature.

35. A computing device as recited in claim 29, wherein the means for parsing the logged data further comprise means for exporting at least a portion of the logged data into one or more database tables in a database such as an SQL database.
